(19) United States
(12) Patent Application Publication
(10) Pub. No.: US 2016/0227804 A1
(43) Pub. Date: Aug. 11, 2016

(54) REDUCED SODIUM CHEESES AND METHODS FOR MAKING SAME

(71) Applicant: NESTEC S.A., Vevey (CH)

(72) Inventor: Praveen Upreti, Twinsburg, OH (US)

(73) Assignee: NESTEC S.A., Vevey (CH)

(21) Appl. No.: 15/023,776

(22) PCT Filed: Sep. 10, 2014
(86) PCT No.: PCT/EP2014/069311

§ 371 Date: Mar. 22, 2016

Related U.S. Application Data
(60) Provisional application No. 61/882,142, filed on Sep. 25, 2013.

(51) Int. Cl. A23C 19/032; A23C 19/072; A23C 19/064; A23C 19/09

(52) U.S. Cl. CPC A23C 19/0326; A23C 19/0904; A23C 19/09; A23C 19/072; A23C 19/064

(57) ABSTRACT

Reduced sodium cheeses and methods for making same are provided. The methods include adding rennet to inoculated milk without a delay from inoculation or with less of a delay from inoculation relative to known methods. The rennet is added to the milk within five minutes after addition of the bacteria, preferably within one minute or simultaneously. The methods use a higher pH at inoculation and/or at cutting and draining of curds to enable a reduction in the amount of sodium chloride added to the curds and thus accelerating the ripening of cheese. Delayed acidification achieved by extending a later stage of processing can obtain a similar final pH relative to known methods. The cheeses have reduced sodium without affecting the flavor profile of the cheese.

### BACKGROUND

The present disclosure generally relates to cheeses and food products containing cheese. More specifically, the present disclosure relates to reduced sodium cheeses and methods for making same.

Cheese is made by adding starter bacteria cultures to milk. The bacteria ferment the lactose in the milk into lactic acid. Subsequently rennet extract is added to the inoculated milk, and the lactic acid produced by the bacteria activates the rennin enzyme in the rennet. Most cheese-making methods involve waiting fifteen to sixty minutes after the starter bacteria is added to the milk before adding the rennet so that the bacteria acclimate themselves to their new environment in preparation for rapid growth and produce an initial amount of lactic acid. See, e.g., Kosikowski, “Cheese and Fermented Milk Foods,” 2nd. Ed. (1982), page 231.

The rennin enzyme in the rennet cleaves part of the kappa-casein from the casein micelle resulting in gelling of the milk. The rennin enzyme also initiates hydrolysis of the alpha- and beta-caseins, which is the first step in the protein hydrolysis sequence that develops characteristic cheese flavors.

Salt is added in one of the processing stages, and at least a portion of the salt is sodium chloride. For some cheeses, such as mozzarella, the only salt that can be used is sodium chloride. Salt is needed to (1) encourage syneresis and control final moisture of the cheese; (2) control the metabolism and survival of the starter bacteria; (3) influence the types of secondary organisms that grow and create flavors during the subsequent ripening period; (4) control enzyme activity in the final cheese; (5) control texture of the final cheese by replacing calcium in the cheese microstructure; (6) provide taste when the cheese is consumed; and (7) provide safety and shelf-life by controlling the growth of undesirable microorganisms.

A lower sodium cheese is desired. Proposed dietary goals in the United States recommend that adults reduce sodium chloride intake from about 15 g per day to 8 g per day. However, sodium chloride strongly influences the ripening of cheese, specifically the rates of flavor and body development and also the quality of the flavors developed. Cheeses that have reduced sodium are typically made using a blend of sodium chloride and, as a sodium chloride substitute, potassium chloride. Other sodium substitutes include magnesium and calcium chlorides. However, consumers observe a foreign flavor, in particular a metallic note, in cheeses made using this methodology. Another attempted solution for sodium reduction is treating the milk with ion-exchange resins, but this method adds significant costs to the cheese-making process.

Another problem associated with cheese processing is the time required for ripening. After salting, cheese typically is ripened for at least five to six months to achieve the desired texture and flavor. The storage of the cheese for the ripening time contributes significantly to the cost of the product. Acceleration of ripening by applying enzymes or microorganisms to the cheese can decrease the ripening time, but the extent to which the ripening time can be decreased by this approach is limited.

### SUMMARY

The present disclosure provides reduced sodium cheeses, methods for making such cheeses, and food products containing such cheeses. The methods can accelerate the ripening of cheese and move acid production from the early stages to later stages of production. The methods comprise adding rennet to inoculated milk without a delay from inoculation or with less of a delay from inoculation relative to known methods.

In a general embodiment, a method for making reduced sodium cheese is provided. The method includes: adding bacteria and rennet to milk substantially simultaneously; and processing the milk to form the cheese.

In an embodiment, the bacteria are added to the milk within one minute of addition of the rennet to the milk.

In an embodiment, the bacteria comprise starter bacteria.

In an embodiment, the processing of the milk comprises adding sodium chloride to curds formed by the milk in an amount of the sodium chloride that does not exceed 1.4 wt % of the curds. The sodium chloride can be the only salt added to the cheese.

In another embodiment, a method for making reduced sodium cheese is provided. The method includes: adding rennet to inoculated milk having a pH of about 6.6; and processing the milk to form the cheese.

In an embodiment, the processing of the milk comprises cutting curds formed by the milk and draining whey from the curds at a pH of about 6.4.

In an embodiment, the processing of the milk comprises adding sodium chloride to the curds, after draining the whey, in an amount that does not exceed 1.4 wt % of the curds.

In an embodiment, the curds undergo knitting until a pH of about 5.4 is reached, and the sodium chloride is added after the pH of about 5.4 is reached.

In an embodiment, the method comprises performing a step selected from the group consisting of heat treatment of the cheese and cold blending of the cheese; and then using the cheese as a food product without any other ingredients.

In another embodiment, a reduced sodium cheese is provided. The cheese comprises up to 0.8 wt % sodium chloride and is made without adding any salt other than sodium chloride.

In an embodiment, the cheese is made by a process comprising a step selected from the group consisting of (i) adding bacteria and rennet to milk substantially simultaneously and (ii) adding rennet to inoculated milk having a pH of about 6.6.

In another embodiment, a food product is provided. The food product includes: a reduced sodium cheese comprising up to 0.8 wt % sodium chloride by weight of the cheese and made without adding any salt other than sodium chloride; and an additional ingredient.

In an embodiment, the additional ingredient is selected from the group consisting of pasta, fruits, vegetables, protein, grains, dough, and combinations thereof.

In an embodiment, the food product comprises a sauce containing the cheese.

An advantage of the present disclosure is to reduce the sodium in cheeses.

Another advantage of the present disclosure is to accelerate the ripening of cheeses.

Still another advantage of the present disclosure is to reduce the sodium in cheeses without using sodium substitutes.

Furthermore, an advantage of the present disclosure is to reduce the sodium in cheeses without decreasing the water activity of the cheese.

Yet another advantage of the present disclosure is to reduce the sodium in cheeses without foreign flavor off-notes.

Another advantage of the present disclosure is to produce cheese using higher concentrations of calcium and phosphorus and a lower concentration of lactic acid.

Still another advantage of the present disclosure is to reduce the sodium in cheeses without significantly lowering the pH of the cheeses.

Yet another advantage of the present disclosure is to reduce the cost of producing cheeses.

Another advantage of the present disclosure is to reduce the sodium in cheeses without ion exchange processing or use of distiller's grain and solubles.

Still another advantage of the present disclosure is to produce cheeses providing improved nutrition to the consumer.

Another advantage of the present disclosure is to provide food products, such as sauces, that have more cheese flavor without compromising nutritional requirements.

Still another advantage of the present disclosure is to reduce the sodium in cheeses up to about 40% relative to standard cheeses.

Another advantage of the present disclosure is to reduce sodium in a cheese sauce while delivering a desirable flavor profile in the cheese sauce.

Still another advantage of the present disclosure is to increase the buffering provided by calcium phosphate in the milk by decreasing the precipitation of the calcium phosphate into the whey.

Furthermore, an advantage of the present disclosure is to reduce the sodium in cheeses without significantly decreasing protein breakdown in the cheeses.

Yet another advantage of the present disclosure is to reduce the sodium in cheddar cheeses while providing a flavor profile of sharp cheddar notes throughout chewing and cooked milk without bitterness.

Additional features and advantages are described herein, and will be apparent from, the following Detailed Description.

### BRIEF DESCRIPTION OF THE DRAWINGS

FIG. 1 is a graph of the pH of various cheeses during ripening in an experimental study.

FIG. 2 is a graph of the soluble nitrogen as a percentage of the total nitrogen during ripening, as indicative of protein breakdown, in the experimental study.

### DETAILED DESCRIPTION

All percentages expressed herein are by weight of the total weight of the composition unless expressed otherwise. When reference is made to the pH, values correspond to pH measured at 25° C. with standard equipment. As used in this disclosure and the appended claims, the singular forms “a,” “an” and “the” include plural referents unless the context clearly dictates otherwise. As used herein, “about” is understood to refer to numbers in a range of numerals. Moreover, all numerical ranges herein should be understood to include all integer, whole or fractions, within the range.

As used herein, “comprising,” “including” and “containing” are inclusive or open-ended terms that do not exclude additional, unrecited elements or method steps. However, the compositions provided by the present disclosure may lack any element that is not specifically disclosed herein. Thus, any embodiment defined herein using the term “comprising” also is a disclosure of embodiments “consisting essentially of” and “consisting of” the recited components.

The present disclosure relates to a method for making a reduced sodium cheese. The method comprises adding bacteria and rennet to the milk simultaneously or substantially simultaneously. “Substantially simultaneously” means within five minutes relative to each other. For example, substantially simultaneous addition includes addition of the rennet to the milk within five minutes after the bacteria are added to the milk. Preferably, the rennet is added to the milk within one minute after the bacteria are added to the milk. In an embodiment, the bacteria and the rennet are added to the milk simultaneously.

Without wishing to be bound by theory, the present inventors believe that the addition of the rennet and the bacteria to the milk substantially simultaneously causes a higher pH of the mixture relative to the typical mixture for which the rennet is added after a delay, such as thirty minutes. The substantially simultaneous addition can delay acidification of the milk. For example, the pH of the inoculated milk to which the rennet is added substantially simultaneously can be about 6.6 or about 6.7, and known methods in which rennet addition is delayed typically have a pH of 6.0 to 6.3.

Milk contains calcium phosphate, and low pHs dissolve more of the calcium phosphate into the whey drained from the cheese relative to higher pHs. Therefore, the higher pH obtained by adding the rennet and the bacteria substantially simultaneously allows an increased calcium phosphate level and correspondingly an increased amount of buffering from the calcium phosphate in the milk. For example, cheeses made according to the method disclosed herein can have a higher calcium level and a higher phosphorus level relative to cheeses made using the same materials but with a delay before rennet addition.

The acidification can be delayed until later in the process. For example, the time at which the curds formed from the milk are subjected to a processing step after the inoculation can be increased to allow the curds to reach the desired final pH.

The present inventors further believe that the increased buffering from the calcium phosphate allows a reduction in sodium without compromising the flavor profile of the resultant cheese. In this regard, bacteria perform more efficiently in low salt environments to produce lactic acid and break down proteins to generate flavor. This effect not only allows the used of reduced sodium without loss of organoleptic quality but also accelerates the ripening process.

Any milk can be used, and the milk is not limited to a specific embodiment. Non-limiting examples of suitable milk include regular full-fat milk, non-fat dry milk, condensed milk, ultra-filtered milk and micro-filtered milk. Moreover, the milk may be from any source. Non-limiting examples of suitable milk sources include cows, buffalo and goat.

Any form of rennet can be used, and the rennet is not limited to a specific embodiment. Non-limiting examples of suitable rennet include mammalian rennet, vegetable rennet, microbial rennet, and fermentation-produced chymosin.

The bacteria can be any starter bacteria and/or non-starter bacteria, and the bacteria are not limited to a specific embodiment. “Starter bacteria” are bacteria that perform fermentation. Non-limiting examples of suitable bacteria for addition to the milk include lactic acid bacteria, e.g. Lactococci, Lactobacilli, and Streptococci.

After the rennet precipitates the casein into curds, the whey can be separated from the curds. For example, the curds can be cut into pieces that are cooked and from which the whey is drained. The curds can be cut and cooked in the whey for a time period sufficient to obtain a desired pH, such as about 6.4. In an embodiment, the curds can be cut and cooked in the whey for a predetermined time period.

The cooking is not limited to specific conditions. Different cooking conditions can be used to obtain different rates and different extents of syneresis and/or to manipulate the growth of different bacteria under different temperature ranges and thereby control lactic acid and flavor production. A non-limiting example of a temperature range for cooking of the curd pieces is 39 to 45° C. For example, in some embodiments, cheddar cheeses can undergo a cooking temperature of 39° C., and mozzarella cheeses can undergo a cooking temperature of 45° C.

The whey can be drained from the curd by physically separating the whey from the curds under gravity. Preferably, the pH of the curds during cutting, cooking and/or draining is about 6.4. The whey can be drained from the curd after a predetermined time period, for example about one hour and forty-five minutes after the addition of the rennet to the milk. After draining, the curds can optionally be washed to reduce lactose, although this method is typically not implemented for cheddar cheeses.

The curds can be fused together in a larger mass in a process known as “knitting.” For example, the curds can undergo knitting while the whey is drained or shortly thereafter. The knitting can be performed by either leaving the curds in contact with each other in a bed of curds, which is referred to as the “matted curd method,” or gently stirring the curds throughout whey draining such that lactic acid production aggregates curds in contact with each other. The whey can be drained from the curd after a predetermined time period, for example about two hours after the addition of the rennet to the milk.

Salting of the curds can be performed by adding dry salt to the curd, submerging curd blocks in brine, or a combination of these methods. In an embodiment, the curds are salted by rubbing dry salt on the surface of the curds, although this method is typically not implemented for cheddar cheeses. Preferably, the curds are salted to a sodium chloride level up to about 1.4 wt % of the curds. In an embodiment, the sodium chloride can be the only salt added to the curds. The curd can be salted after a time period sufficient to obtain a desired pH, for example a pH of about 5.4. This time period may result in a longer length of knitting/transforming, considering that the acid development is delayed in the methods according to the present disclosure. In an embodiment, the curd can be salted after a predetermined time period, such as about five hours for example, after the addition of the rennet to the milk.

The time period after which the curds are salted can achieve delayed acidification. This time period can be increased to compensate for the substantially simultaneous addition of the bacteria and the rennet to the milk and the resulting higher pH of the mixture relative to the typical mixture for which the rennet is added after a delay. For example, as noted above, the pH of the inoculated milk to which the rennet is added substantially simultaneously can be about 6.6 or about 6.7, and known methods in which rennet addition is delayed typically have a pH of 6.0 to 6.3. Nevertheless, a similar final pH of the curds before salting can be the same, such as about 5.4, because the amount of time of a processing step after the inoculation can be increased in the methods according to the present disclosure. For example, to achieve delayed acidification, the time spent knitting the cheese and/or the time between knitting and salting can be increased relative to known methods.

After salting, the curds can be pressed to remove moisture. In an embodiment, the curds can be pressed immediately after salting.

After pressing, the curds undergo aging. The aging is not limited to a specific embodiment, but non-limiting examples of aging conditions are refrigerated temperatures (about 38° F.) and elevated temperatures (about 55° F.). Preferably, the time period of aging is from two to three months and is less than the typical aging period (about six months). As noted above, the present inventors believe that the increased calcium phosphate levels not only allow the used of reduced sodium without loss of organoleptic quality but also accelerate the ripening process.

After aging, the sodium chloride level of the cheese is preferably up to about 0.8%. The sodium chloride level of the cheese provided by the present disclosure can be reduced up to about 40% relative to the typical cheese-making process in which the rennet is added to the milk after a delay from inoculation, such as thirty minutes.

The present disclosure also provides a food product and a method for making same. The food product can comprise any of the reduced sodium cheeses disclosed herein. The food product can be made by combining any of the reduced sodium cheeses disclosed herein with at least one other ingredient, such as pasta, fruits, vegetables, protein, grains such as rice, and the like. For example, the reduced sodium cheese can be added to at least one other ingredient to form macaroni and cheese; a dough-based product, such as a sandwich or a pizza; potatoes au gratin; a food product at least partially covered in cheese sauce; or the like. In an embodiment, the cheese is mixed with a liquid, such as a liquid containing one or more dairy ingredients, to form a sauce that is used in the food product. The reduced sodium cheese may be a foundation for a culinary product such as for use in a soup, a spread or a condiment. The food product comprising the reduced sodium cheese is not limited to a specific embodiment, and the food product can be any food product comprising cheese known the skilled artisan. The resultant food product comprising the reduced sodium cheese can be chilled, frozen or otherwise preserved for later reheating and consumption by the consumer.

### EXAMPLES

By way of example and not limitation, the following non-limiting examples are illustrative of various embodiments provided by the present disclosure.

### Example 1

The present inventors conducted an experimental comparison of cheese prepared by adding rennet 30 minutes after inoculation, then salting the curds to 2.7 wt % sodium chloride and then ripening at 7° C. (“standard cheese” or “cheese 1”), cheese prepared by adding rennet 30 minutes after inoculation, then salting the curds to 2.7 wt % sodium chloride and then ripening at 13° C. (“standard cheese with accelerated ripening” or “cheese 2”), cheese prepared by adding rennet 30 minutes after inoculation, then salting the curds to 1.4 wt % sodium chloride and then ripening at 13° C. (“standard cheese with low sodium and accelerated ripening” or “cheese 3”), and an embodiment of cheese provided by the present disclosure, namely cheese prepared by adding rennet and bacteria simultaneously, then salting the curds to 1.4 wt % sodium chloride and then ripening at 13° C. (“inventive cheese” or “cheese 4”).

The final sodium chloride level of these cheeses after ripening and the resultant sensory profiles are shown in the following table.

TABLE 1

| | Cheese No. | | | |
|---|---|---|---|---|
| | 1 | 2 | 3 | 4 |
| Salt | 1.54% | 1.50% | 0.80% | 0.76% |
| | (s.d. 0.08) | (s.d. 0.04) | (s.d. 0.04) | (s.d. 0.07) |
| Sensory | Moderate | Moderate | Stronger flavor | Sharp cheddar |
| profile | overall | overall cheddar | profile, sharp | notes |
| | intensity, | flavor, fruity, | cheddar note | throughout |
| | sour, cooked | cooked milk, | later in | chewing, |
| | milk, buttery | sulfury | chewing, | fruity, cooked |
| | and sharp | | cooked milk, | milk, no |
| | | | some bitterness | bitterness |

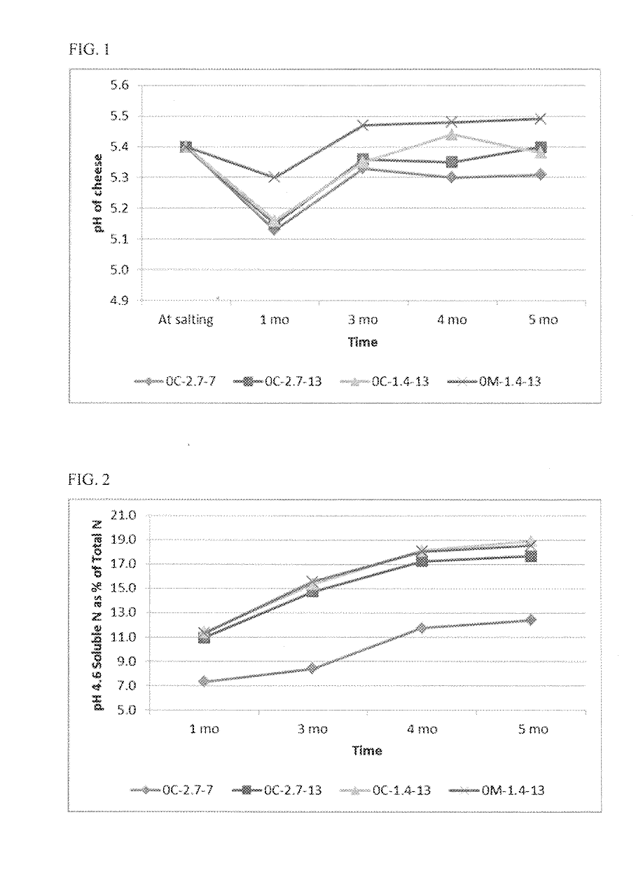

The pH of these cheeses during ripening is shown in the following table and in FIG. 1.

TABLE 2

| Cheese No. | At salting | 1 mo. | 3 mo. | 4 mo. | 5 mo. |
|---|---|---|---|---|---|
| 1 | 5.40 | 5.13 | 5.33 | 5.30 | 5.31 |
| 2 | 5.40 | 5.15 | 5.36 | 5.35 | 5.40 |
| 3 | 5.40 | 5.16 | 5.35 | 5.44 | 5.38 |
| 4 | 5.40 | 5.30 | 5.47 | 5.48 | 5.49 |

The soluble nitrogen as a percentage of the total nitrogen during ripening, as indicative of protein breakdown, is shown in the following table and in FIG. 2. Protein breakdown is strongly correlated with flavor development, and the more protein breakdown that occurs, the more mature the cheese. This data demonstrates that cheese ripening is accelerated in Cheese 4 relative to standard full sodium cheese, namely Cheeses 1 and 2.

TABLE 3

| Cheese No. | 1 mo. | 3 mo. | 4 mo. | 5 mo. |
|---|---|---|---|---|
| 1 | 7.3 | 8.4 | 11.7 | 12.4 |
| 2 | 11.0 | 14.8 | 17.3 | 17.7 |
| 3 | 11.4 | 15.4 | 18.1 | 18.9 |
| 4 | 11.3 | 15.6 | 18.1 | 18.5 |

### Example 2

A sensory analysis was performed using twenty tasters. Two cheeses were prepared and used in a macaroni and cheese food product. The first cheese was prepared by adding rennet 30 minutes after inoculation, then salting the curds to 2.7 wt % sodium chloride and then ripening at 7° C. (“standard cheese”). The second cheese was prepared by adding rennet and bacteria simultaneously, then salting the curds to 1.4 wt % sodium chloride and then ripening at 13° C. (“inventive cheese”).

Each taster was given three samples. Two or the samples contained the same cheese, and one of the samples contained the other type of cheese. The tasters then indicated which sample they thought did not taste like the others. Thirty six tests were performed. In twenty of the tests, the taster was incorrect in identifying the sample which contained a different type of cheese relative to the other samples. In sixteen of the tests, the taster was correct in identifying the sample which contained a different type of cheese relative to the other samples.

The resultant level of significance was 95%, and if the cheeses were distinguishable the minimum number of correct tests should have been 18. Instead, only 16 correct tests occurred. This data indicates that the inventive cheese has organoleptic properties indistinguishable from the standard cheese.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for making reduced sodium cheese comprising the steps of:
adding bacteria and rennet to milk substantially simultaneously; and
processing the milk to form the cheese.

2. The method of claim 1, wherein the bacteria are added to the milk within one minute of addition of the rennet to the milk.

3. The method of claim 1, wherein the bacteria comprise starter bacteria.

4. The method of claim 1, wherein the processing of the milk comprises adding sodium chloride to curds formed by the milk in an amount of the sodium chloride that does not exceed 1.4 wt % of the curds.

5. The method of claim 4, wherein the sodium chloride is the only salt added to the cheese.

6. A method for making reduced sodium cheese comprising the steps of:
adding rennet to inoculated milk having a pH of about 6.6; and
processing the milk to form the cheese.

7. The method of claim 6, wherein the processing of the milk comprises cutting curds formed by the milk and draining whey from the curds at a pH of about 6.4.

8. The method of claim 7, wherein the processing of the milk comprises adding sodium chloride to the curds, after draining the whey, in an amount that does not exceed 1.4 wt % of the curds.

9. The method of claim 8, wherein the curds undergo knitting until a pH of about 5.4 is reached, and the sodium chloride is added after the pH of about 5.4 is reached.

10. The method of claim 6, comprising:
performing a step selected from the group consisting of heat treatment of the cheese; and cold blending of the cheese; and
then using the cheese as a food product without any other ingredients.

11. A reduced sodium cheese comprising up to 0.8 wt % sodium chloride and made without adding any salt other than sodium chloride.

12. The cheese of claim 11, wherein the cheese is made by a process comprising a step selected from the group consisting of: (i) adding bacteria and rennet to milk substantially simultaneously and (ii) adding rennet to inoculated milk having a pH of about 6.6.

13. A food product comprising:
a reduced sodium cheese comprising up to 0.8 wt % sodium chloride by weight of the cheese and made without adding any salt other than sodium chloride; and
an additional ingredient.

14. The food product of claim 13, wherein the additional ingredient is selected from the group consisting of pasta, fruits, vegetables, protein, grains, dough, and combinations thereof.

15. The food product of claim 13, wherein the food product comprises a sauce containing the cheese.
